(19) United States
(12) Patent Application Publication
(10) Pub. No.: US 2025/0013512 A1
(43) Pub. Date: Jan. 9, 2025

(54) RESOURCE SCHEDULING FOR APPLICATIONS

(71) Applicant: Cisco Technology, Inc., San Jose, CA (US)

(72) Inventor: Prasenjit Sarkar, Isleworth (GB)

(21) Appl. No.: 18/219,184

(22) Filed: Jul. 7, 2023

(51) Int. Cl. G06F 9/54; G06F 9/50

(52) U.S. Cl. CPC G06F 9/546; G06F 9/5055; G06F 2209/5022; G06F 2209/503

(57) ABSTRACT

In one embodiment, a device determines whether applications in a messaging system are data producers or data consumers. The device determines workloads of the applications. The device assigns message brokers of the messaging system to the applications based on the workloads of the applications and whether the applications are data producers or data consumers.

### TECHNICAL FIELD

The present disclosure relates generally to computer networks, and, more particularly, to resource scheduling for applications.

### BACKGROUND

Many online applications today rely on the real-time streaming of input data. In general, this allows an application to act upon the input data almost immediately after a data source generates that data. Examples of such applications that support real-time data streaming now include social media applications, financial applications, and online gaming applications, among many others.

To support the messaging between the various data sources and an online application, there are now various real-time messaging systems, such as Apache Kafka. In these systems, a broker generally stores and process messages produced by data producers and consumed by data consumers. For example, a financial application may consume stock prices that are sent via a messaging system in real-time.

From a resource standpoint, though, real-time messaging systems are agnostic as to the types of data being sent, as well as to the types of applications supported by the real-time messaging systems. It is possible that this agnostic approach obfuscates different patterns in terms of memory usage, processing usage, and/or performance degradation associated with computing devices that execute the applications.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example observability intelligence platform;

FIG. 4 illustrates an example flow utilizing a simplex algorithm for resource scheduling for applications;

FIG. 5 illustrates an example flow utilizing a branch and bound algorithm for resource scheduling for applications;

FIG. 6 illustrates an example of resource scheduling for applications in a computing system; and

FIG. 7 illustrates an example simplified procedure for resource scheduling for applications.

### DESCRIPTION OF EXAMPLE EMBODIMENTS

### Overview

According to one or more embodiments of the disclosure, a device determines whether applications in a messaging system are data producers or data consumers. The device determines workloads of the applications. The device assigns message brokers of the messaging system to the applications based on the workloads of the applications and whether the applications are data producers or data consumers.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

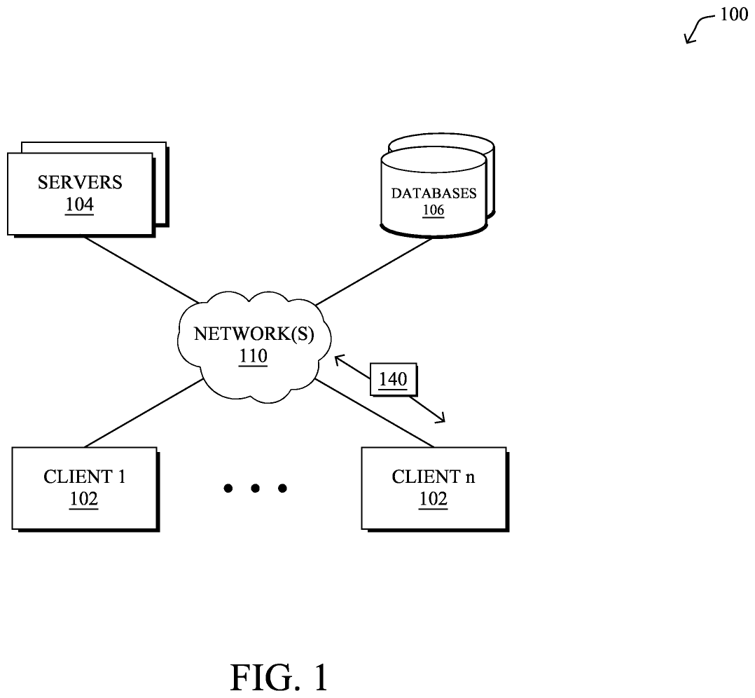

FIG. 1 is a schematic block diagram of an example simplified computing system 100 illustratively comprising any number of client devices 102 (e.g., a first through nth client device), one or more servers 104, and one or more databases 106, where the devices may be in communication with one another via any number of networks 110. The one or more networks 110 may include, as would be appreciated, any number of specialized networking devices such as routers, switches, access points, etc., interconnected via wired and/or wireless connections. For example, devices 102-104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some embodiments, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

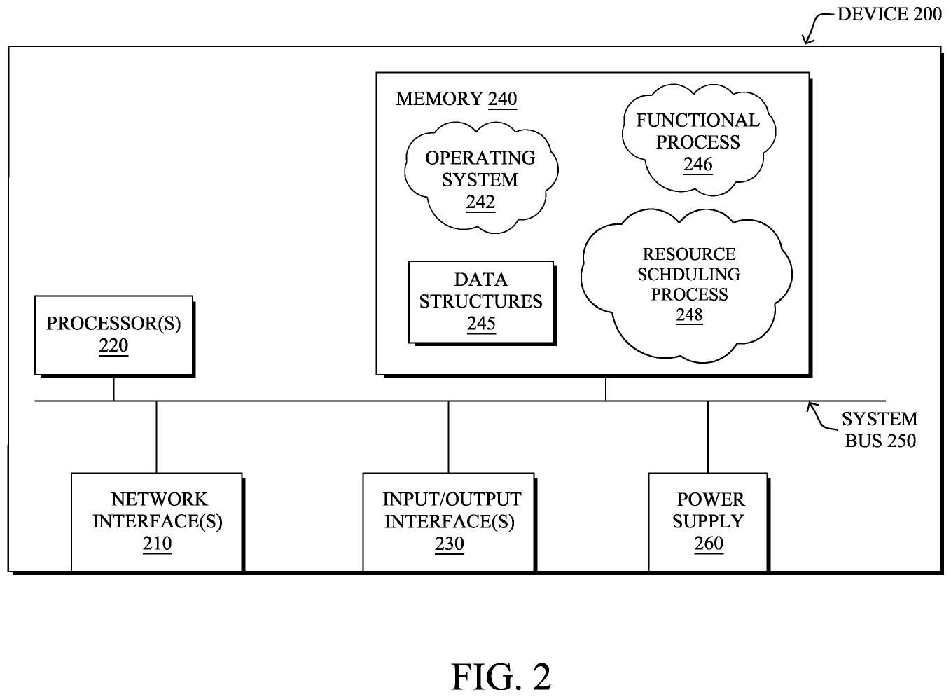

FIG. 2 is a schematic block diagram of an example node/device 200 (e.g., an apparatus) that may be used with one or more embodiments described herein, e.g., as any of the devices 102-106 shown in FIG. 1 above. Device 200 may comprise one or more network interfaces 210 (e.g., wired, wireless, etc.), at least one processor 220, and a memory 240 interconnected by a system bus 250, as well as a power supply 260 (e.g., battery, plug-in, etc.).

The network interface(s) 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the network interfaces 210 for storing software programs and data structures associated with the embodiments described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise a one or more functional processes 246, and on certain devices, an illustrative “resource scheduling” process 248, as described herein. Notably, functional processes 246, when executed by processor(s) 220, cause each particular device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

### —Observability Intelligence Platform—

As noted above, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a software as a service (SaaS) over a network, such as the Internet. As an example, a distributed application can be implemented as a SaaS-based web service available via a web site that can be accessed via the Internet. As another example, a distributed application can be implemented using a cloud provider to deliver a cloud-based service.

Users typically access cloud-based/web-based services (e.g., distributed applications accessible via the Internet) through a web browser, a light-weight desktop, and/or a mobile application (e.g., mobile app) while the enterprise software and user's data are typically stored on servers at a remote location. For example, using cloud-based/web-based services can allow enterprises to get their applications up and running faster, with improved manageability and less maintenance, and can enable enterprise IT to more rapidly adjust resources to meet fluctuating and unpredictable business demand. Thus, using cloud-based/web-based services can allow a business to reduce Information Technology (IT) operational costs by outsourcing hardware and software maintenance and support to the cloud provider.

However, a significant drawback of cloud-based/web-based services (e.g., distributed applications and SaaS-based solutions available as web services via web sites and/or using other cloud-based implementations of distributed applications) is that troubleshooting performance problems can be very challenging and time consuming. For example, determining whether performance problems are the result of the cloud-based/web-based service provider, the customer's own internal IT network (e.g., the customer's enterprise IT network), a user's client device, and/or intermediate network providers between the user's client device/internal IT network and the cloud-based/web-based service provider of a distributed application and/or web site (e.g., in the Internet) can present significant technical challenges for detection of such networking related performance problems and determining the locations and/or root causes of such networking related performance problems. Additionally, determining whether performance problems are caused by the network or an application itself, or portions of an application, or particular services associated with an application, and so on, further complicate the troubleshooting efforts.

Certain aspects of one or more embodiments herein may thus be based on (or otherwise relate to or utilize) an observability intelligence platform for network and/or application performance management. For instance, solutions are available that allow customers to monitor networks and applications, whether the customers control such networks and applications, or merely use them, where visibility into such resources may generally be based on a suite of “agents” or pieces of software that are installed in different locations in different networks (e.g., around the world).

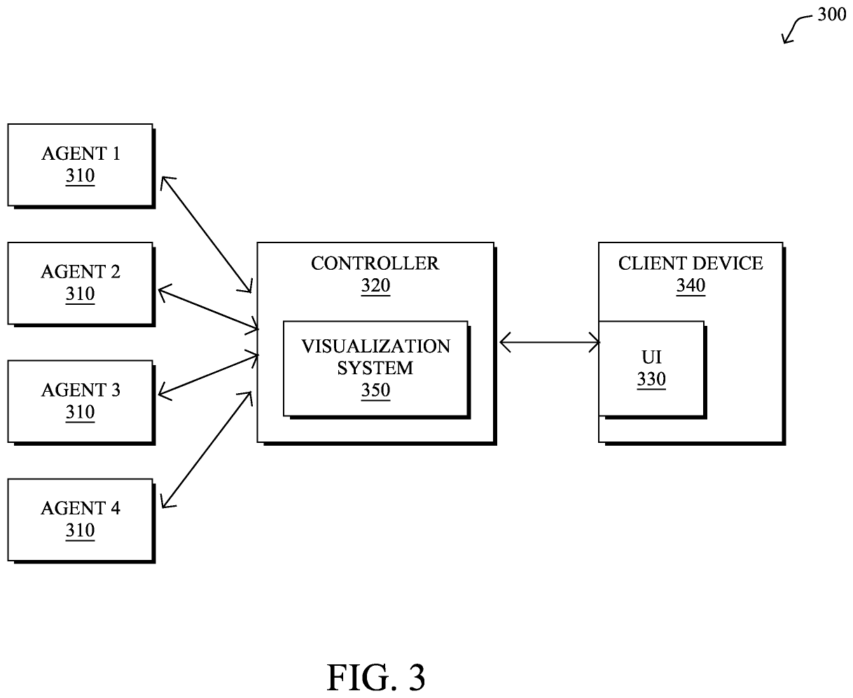

Specifically, as discussed with respect to illustrative FIG. 3 below, performance within any networking environment may be monitored, specifically by monitoring applications and entities (e.g., transactions, tiers, nodes, and machines) in the networking environment using agents installed at individual machines at the entities. As an example, applications may be configured to run on one or more machines (e.g., a customer will typically run one or more nodes on a machine, where an application consists of one or more tiers, and a tier consists of one or more nodes). The agents collect data associated with the applications of interest and associated nodes and machines where the applications are being operated. Examples of the collected data may include performance data (e.g., metrics, metadata, etc.) and topology data (e.g., indicating relationship information), among other configured information. The agent-collected data may then be provided to one or more servers or controllers to analyze the data.

Examples of different agents (in terms of location) may comprise cloud agents (e.g., deployed and maintained by the observability intelligence platform provider), enterprise agents (e.g., installed and operated in a customer's network), and endpoint agents, which may be a different version of the previous agents that is installed on actual users' (e.g., employees') devices (e.g., on their web browsers or otherwise). Other agents may specifically be based on categorical configurations of different agent operations, such as language agents (e.g., Java agents, .Net agents, PHP agents, and others), machine agents (e.g., infrastructure agents residing on the host and collecting information regarding the machine which implements the host such as processor usage, memory usage, and other hardware information), and network agents (e.g., to capture network information, such as data collected from a socket, etc.).

Each of the agents may then instrument (e.g., passively monitor activities) and/or run tests (e.g., actively create events to monitor) from their respective devices, allowing a customer to customize from a suite of tests against different networks and applications or any resource that they're interested in having visibility into, whether it's visibility into that end point resource or anything in between, e.g., how a device is specifically connected through a network to an end resource (e.g., full visibility at various layers), how a website is loading, how an application is performing, how a particular business transaction (or a particular type of business transaction) is being effected, and so on, whether for individual devices, a category of devices (e.g., type, location, capabilities, etc.), or any other suitable embodiment of categorical classification.

FIG. 3 is a block diagram of an example observability intelligence platform 300 that can implement one or more aspects of the techniques herein. The observability intelligence platform is a system that monitors and collects metrics of performance data for a network and/or application environment being monitored. At the simplest structure, the observability intelligence platform includes one or more agents 310 and one or more servers/controllers 320. Agents may be installed on network browsers, devices, servers, etc., and may be executed to monitor the associated device and/or application, the operating system of a client, and any other application, API, or another component of the associated device and/or application, and to communicate with (e.g., report data and/or metrics to) the controller(s) 320 as directed. Note that while FIG. 3 shows four agents (e.g., Agent 1 through Agent 4) communicatively linked to a single controller, the total number of agents and controllers can vary based on a number of factors including the number of networks and/or applications monitored, how distributed the network and/or application environment is, the level of monitoring desired, the type of monitoring desired, the level of user experience desired, and so on.

For example, instrumenting an application with agents may allow a controller to monitor performance of the application to determine such things as device metrics (e.g., type, configuration, resource utilization, etc.), network browser navigation timing metrics, browser cookies, application calls and associated pathways and delays, other aspects of code execution, etc. Moreover, if a customer uses agents to run tests, probe packets may be configured to be sent from agents to travel through the Internet, go through many different networks, and so on, such that the monitoring solution gathers all of the associated data (e.g., from returned packets, responses, and so on, or, particularly, a lack thereof). Illustratively, different “active” tests may comprise HTTP tests (e.g., using curl to connect to a server and load the main document served at the target), Page Load tests (e.g., using a browser to load a full page—i.e., the main document along with all other components that are included in the page), or Transaction tests (e.g., same as a Page Load, but also performing multiple tasks/steps within the page—e.g., load a shopping website, log in, search for an item, add it to the shopping cart, etc.).

The controller 320 is the central processing and administration server for the observability intelligence platform. The controller 320 may serve a browser-based user interface (UI) 330 that is the primary interface for monitoring, analyzing, and troubleshooting the monitored environment. Specifically, the controller 320 can receive data from agents 310 (and/or other coordinator devices), associate portions of data (e.g., topology, business transaction end-to-end paths and/or metrics, etc.), communicate with agents to configure collection of the data (e.g., the instrumentation/tests to execute), and provide performance data and reporting through the interface 330. The interface 330 may be viewed as a web-based interface viewable by a client device 340. In some implementations, a client device 340 can directly communicate with controller 320 to view an interface for monitoring data. The controller 320 can include a visualization system 350 for displaying the reports and dashboards related to the disclosed technology. In some implementations, the visualization system 350 can be implemented in a separate machine (e.g., a server) different from the one hosting the controller 320.

Notably, in an illustrative Software as a Service (SaaS) implementation, an instance of controller 320 may be hosted remotely by a provider of the observability intelligence platform 300. In an illustrative on-premises (On-Prem) implementation, an instance of controller 320 may be installed locally and self-administered.

The controllers 320 receive data from different agents 310 (e.g., Agents 1-4) deployed to monitor networks, applications, databases and database servers, servers, and end user clients for the monitored environment. Any of the agents 310 can be implemented as different types of agents with specific monitoring duties. For example, application agents may be installed on each server that hosts applications to be monitored. Instrumenting an agent adds an application agent into the runtime process of the application.

Database agents, for example, may be software (e.g., a Java program) installed on a machine that has network access to the monitored databases and the controller. Standalone machine agents, on the other hand, may be standalone programs (e.g., standalone Java programs) that collect hardware-related performance statistics from the servers (or other suitable devices) in the monitored environment. The standalone machine agents can be deployed on machines that host application servers, database servers, messaging servers, Web servers, etc. Furthermore, end user monitoring (EUM) may be performed using browser agents and mobile agents to provide performance information from the point of view of the client, such as a web browser or a mobile native application. Through EUM, web use, mobile use, or combinations thereof (e.g., by real users or synthetic agents) can be monitored based on the monitoring needs.

Note that monitoring through browser agents and mobile agents are generally unlike monitoring through application agents, database agents, and standalone machine agents that are on the server. In particular, browser agents may generally be embodied as small files using web-based technologies, such as JavaScript agents injected into each instrumented web page (e.g., as close to the top as possible) as the web page is served, and are configured to collect data. Once the web page has completed loading, the collected data may be bundled into a beacon and sent to an EUM process/cloud for processing and made ready for retrieval by the controller. Browser real user monitoring (Browser RUM) provides insights into the performance of a web application from the point of view of a real or synthetic end user. For example, Browser RUM can determine how specific Ajax or iframe calls are slowing down page load time and how server performance impact end user experience in aggregate or in individual cases. A mobile agent, on the other hand, may be a small piece of highly performant code that gets added to the source of the mobile application. Mobile RUM provides information on the native mobile application (e.g., iOS or Android applications) as the end users actually use the mobile application. Mobile RUM provides visibility into the functioning of the mobile application itself and the mobile application's interaction with the network used and any server-side applications with which the mobile application communicates.

In general, data/metrics collected relate to the topology and/or overall performance of the network and/or application (or business transaction) or associated infrastructure, such as, e.g., load, average response time, error rate, percentage CPU busy, percentage of memory used, etc. The controller UI can thus be used to view all of the data/metrics that the agents report to the controller, as topologies, heatmaps, graphs, lists, and so on. Illustratively, data/metrics can be accessed programmatically using a Representational State Transfer (REST) API (e.g., that returns either the JavaScript Object Notation (JSON) or the extensible Markup Language (XML) format). Also, the REST API can be used to query and manipulate the overall observability environment.

Those skilled in the art will appreciate that other configurations of observability intelligence may be used in accordance with certain aspects of the techniques herein, and that other types of agents, instrumentations, tests, controllers, and so on may be used to collect data and/or metrics of the network(s) and/or application(s) herein. Also, while the description illustrates certain configurations, communication links, network devices, and so on, it is expressly contemplated that various processes may be embodied across multiple devices, on different devices, utilizing additional devices, and so on, and the views shown herein are merely simplified examples that are not meant to be limiting to the scope of the present disclosure.

### Resource Scheduling for Applications

As noted above, a key challenge that may arise in the above scenarios, and in messaging systems in general, is the allocation of resources to message brokers such that the message brokers are neither under provisioned with resources nor over provisioned with resources. However, current approaches are agnostic to the types of data being utilized by such message brokers and to the types of applications supported by the message brokers. Accordingly, the present disclosure seeks to address the allocation of resources by solving issues inherent in some approaches that include messaging systems by providing message brokers that are part of the data storing platform (as opposed to the data processing platform) and are configured to determine data types ingested by the messaging system, as well as application types associated with the messaging system to optimize deployment of message brokers for specific workloads.

The techniques introduced herein allow for a messaging system to assign brokers to different types of applications through the use of resource scheduling. In general, a messaging system facilitates the transfer of data from one application (e.g., a microservice) to another application and/or from one device to another device. Non-limiting examples of such messaging systems that are currently available include Kafka, RabbitMQ. Azure Logic Apps, Confluent, and MuleSoft Anypoint Platform, among many others.

Kafka, for example, is a distributed publish-subscribe messaging system and a robust queue that can handle a high volume of data and enables messages to be passed from one end-point to another. Kafka is suitable for both offline and online message consumption. For example, Kafka is a distributed system consisting of servers and clients that communicate via a high-performance TCP network protocol. Kafka can be deployed on a cluster (e.g., a Kubernetes cluster) or similar distributed computing environment. In general, Kafka, like many other messaging systems, lets you read data in real time from a topic, process that data (such as by filtering, grouping, or aggregating it) and then write the resulting data into another topic or to other systems of record.

In various embodiments, a messaging system utilizes dedicated brokers that are assigned to different applications and/or microservices, based on the type of application and/or microservice. As discussed in more detail herein, utilization of dedicated brokers in the messaging system allows for performance of various computing systems to be improved in comparison to other approaches. For example, by utilizing dedicated brokers that are assigned to different applications and/or microservices, the brokers can further be assigned to specific producers and/or consumers, thereby allowing for optimization of performance of workloads assigned to the various brokers.

For example, if a producer has relatively large messages to process and therefore requires a relatively large amount of processing resources (e.g., central processing unit resources, etc.), the messaging system can assign a broker that is capable of processing such messages. This can ensure that the broker that is assigned to this type of message traffic is adequately provisioned to handle the workload associated with the producer. This in turn results in an overall increase in performance in a network in which embodiments of the present disclosure operate in comparison to previous approaches.

In various embodiments, the messaging system can leverage an application-aware scheduling paradigm (e.g., set of executable instructions, algorithm, etc.) to allocate resources (e.g., processing resources, memory resources, etc.) associated with the messaging system and/or network to different producers and consumers. That is, embodiments of the present disclosure allow for particular characteristics of applications, application types, and/or application behaviors to be considered when allocating resources to different producers and/or to different consumers.

For example, a machine learning application may require different resources than a real-time data processing application, and embodiments of the present disclosure allow for different brokers to be allocated to these different types of applications to improve the overall functioning of a network and/or computing environment. In addition, a scheduling algorithm may be employed to optimize allocation of brokers in accordance with embodiments of the present disclosure.

As described in more detail, herein, in one embodiment, application-aware scheduling can be implemented in the messaging system using a simplex algorithm. Embodiments are not so limited, however, in some embodiments, application-aware scheduling can be implemented in the messaging system using a branch and bound algorithm. It will be appreciated that the messaging system may apply either of these algorithms, or other suitable algorithms, without departing from the scope of the disclosure. In some embodiments, the messaging system may apply the simplex algorithm, the branch and bound algorithm, or any other suitable algorithm by defining resource scheduling as an optimization problem and then solving (e.g., optimizing) the optimization problem.

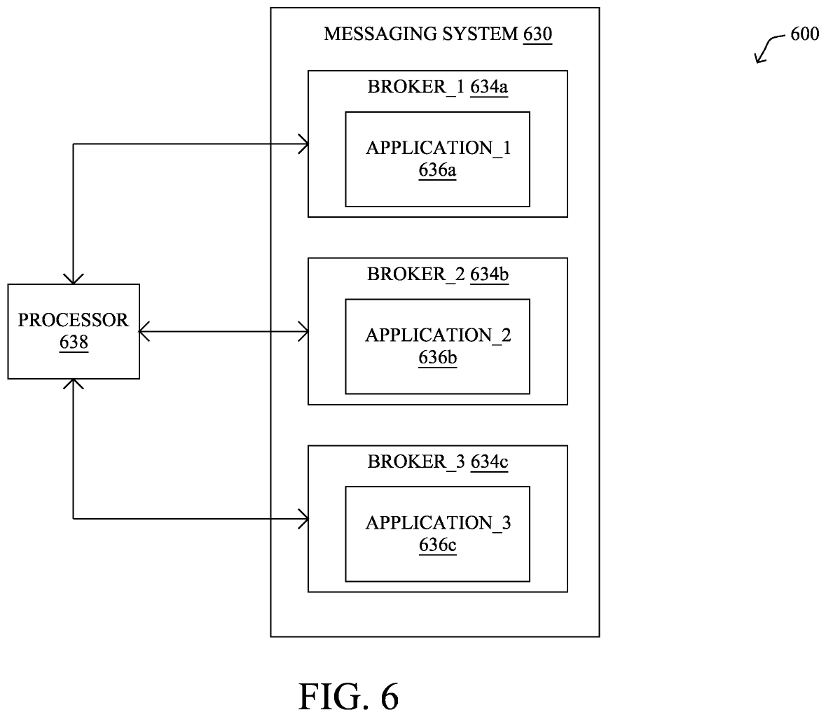

In a non-limiting example, a messaging system (e.g., a Kafka messaging system) can, in connection with a processor (such as the processor 636 of FIG. 6, described below), utilize one or more mathematical models involving the following equations to allocate resources associated with one or more brokers to various producers and/or consumers. Such mathematical models may be implemented by hardware (e.g., by the processors, controllers, logic, etc. described herein) executing instructions to compute such models. For example, in some embodiments, the summation of p[i] multiplied by x[i], where p[i] represents a priority associated with an i^{th} producer and x[i] is a binary variable that represents whether the producer i is assigned to a broker can be maximized (i.e., x[i] is given a value of “1” or “0” depending on whether or not the producer i is assigned to a broker), as given by Equation 1.

$$Σ p [ i ] * x [ i ] \qquad ( Equation 1 )$$

In some embodiments, Equation 1 can be maximized subject to the summation of r[j][i] multiplied by x[i], as given by Equation 2. It is noted that, in Equation 2, the summation is further subjected to the constraint that the summation of r[j][i] multiplied by x[i] is less than or equal to c[j] for all j, where r[j][i] represents the resource requirements of a producer, i, on a broker, j, and where c[j] represents a resource capacity of the broker j.

$$Σ r [ j ] [ i ] * x [ i ] \qquad ( Equation 2 )$$

Although various embodiments are discussed herein in the context of various models that utilize Equation 1 and Equation 2, it will be appreciated that other models and/or equations can be, similar to Equation 1 and Equation 2, implemented in hardware (e.g., by the processors, controllers, logic, etc. described herein) executing instructions to compute such models without departing from the scope of the disclosure.

The objective of the model represented by Equation 1 and Equation 2 is to maximize the total priority of the producers that are assigned to brokers, subject to the constraint that the resource requirements of the producers do not exceed the capacity of the brokers. To solve this objective, the messaging system can then use the simplex algorithm (as described in more detail, below). In general, the simplex algorithm solves a linear programming problem that minimizes the cost of allocating resources between producers and consumers. In the alternative, to solve the objective, the messaging system can also use the branch and bound algorithm (as described in more detail, below), which solves a mixed integer programming issue that maximizes the overall performance of the messaging system.

In some embodiments, additional constraints and objectives functions could also be used to, for example, reflect the unique characteristics of each application type into the resource scheduling algorithm. For instance, to prioritize real-time data over batch data processing, the messaging system could solve an objective function that maximizes real-time data throughput and add a constraint to limit the resources available for batch data, among other possibilities.

### Dedicated Broker Using Simplex Algorithm:

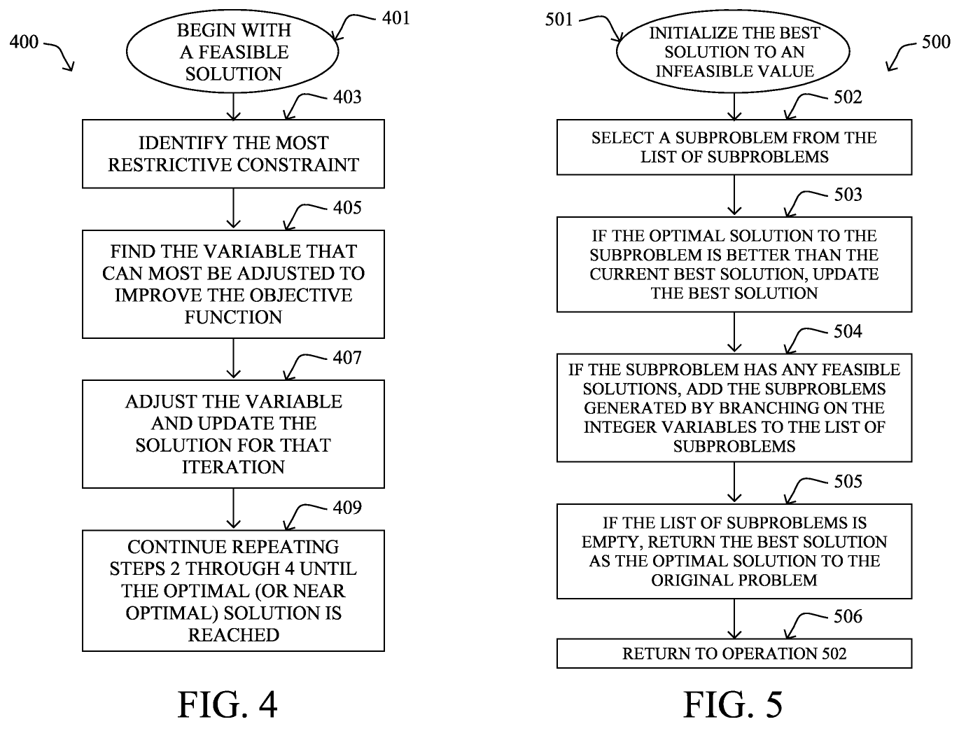

FIG. 4 illustrates an example flow utilizing a simplex algorithm for resource scheduling for applications. As shown in FIG. 4, in some embodiments, the messaging system and/or processor can use a simplex algorithm to solve the linear programming problem defined by Equation 1 and Equation 2. As will be appreciated, the simplex algorithm may be utilized to find a feasible solution and then, through an iterative process, improve on subsequent solutions until an optimal (or near optimal) solution is reached. A set of rules may be used to determine which variables are to be adjusted for each iteration of the iterative process to find the optimal (or near optimal) solution. Once the optimal (or near optimal) solution has been reached, the simplex algorithm is generally terminated. In addition, if it is determined that the simplex algorithm will not reach an optimal (or near optimal) solution, the algorithm can be terminated in response to the determination that the solution will be impossible, will not converge, etc.

In accordance with the present disclosure, the resource scheduling problem described herein (e.g., how to optimize allocation of resources based on workloads associated with the various brokers that arise from execution of applications using the messaging system) can be formulated as a linear programming issue and the simplex algorithm can be applied to optimize the solution to this linear programming issue. As mentioned above, the variables input into the simplex algorithm are used to allocate resources to consumers and producers that participate in the messaging system.

In general, the objective is to minimize the cost of all the resources being allocated to various brokers and, hence, to the producers and consumers associated with the messaging system. In some embodiments, constraints, such as the maximum capacity (in terms of resource consumption) for the brokers, as well as the minimum resources required by each of the producers and consumers, may be defined prior to execution of the simplex algorithm. Once the resource scheduling problem is formulated, the messaging system and/or processor may utilize the simplex algorithm to find the optimal (or near optimal) solution as follows:
1. At operation 401, the flow 400 may begin with a feasible solution such as one that evenly allocates resources to producers and consumers.
2. At operation 403, the flow 400 may identify the most restrictive constraint. This is the constraint closest to being fulfilled.
3. At operation 405, the flow 400 may find the variable that can most be adjusted to improve the objective function while still meeting the constraints.
4. At operation 407, the flow 400 may adjust the variable and update the solution for that iteration.
5. At operation 409, the flow 400 may continue repeating steps 2 through 4 until the optimal (or near optimal) solution is reached, or until it is determined that the simplex algorithm will fail to reach an acceptable solution.

### Dedicated Broker Using Branch and Bound Algorithm:

FIG. 5 illustrates an example flow utilizing a branch and bound algorithm for resource scheduling for applications. As shown in FIG. 5, in some embodiments, the messaging system and/or processor can use a branch and bound algorithm to solve the resource scheduling problem defined by Equation 1 and Equation 2. As will be appreciated, a branch and bound algorithm generally divides the solution space into smaller problems and solves each of such smaller problems individually. A set of rules may be used to determine which subproblem should be solved next to find the optimal (or near optimal) solution. Once the optimal (or near optimal) solution has been reached, the branch and bound algorithm is generally terminated. In addition, if it is determined that the branch and bound algorithm will not reach an optimal (or near optimal) solution, the algorithm can be terminated in response to the determination that the solution will be impossible, will not converge, etc.

In these embodiments, the resource scheduling problem can be formulated as an integer mixed programming problem to define a branch and bound algorithm. This includes defining the decision variables, objective function, and constraints. To store subproblems, the messaging system may use a queue. Then, during each iteration, the messaging system and/or processor removes the next subproblem and verify that it is possible to be solved. If the subproblem can be solved, the messaging system and/or processor updates the upper limit and the optimal solution. If the subproblem is not feasible, the messaging system and/or processor then divides that subproblem into two subproblems and sets one of the variables to “0” or “1.” If their bounds are higher than the current upper limit, the messaging system and/or processor then adds them to the queue.

The branch and bound algorithm is generally efficient in searching the solution space and finding the best solution to the resource scheduling problem in Kafka and other messaging systems by iteratively solving the subproblems in the queue. The decision variables may be defined as the allocation of resources among different producers and consumers. In addition, the objective function is the total cost of allocating resources, or the overall performance of the messaging system. Constraints may also be defined so as to reflect the broker's resource limits and the characteristics of various application types, such as throughput of real-time data or processing times for batch data. Once the resource scheduling problem is formulated, the branch and bound algorithm may proceed as follows:
1. At operation 501, the flow 500 may initialize the best solution to an infeasible value, such as a very large negative number.
2. At operation 502, the flow 500 may select a subproblem from the list of subproblems and solve it to optimality using a mathematical optimization technique.
3. At operation 503, the flow 500 may, if the optimal solution to the subproblem is better than the current best solution, update the best solution.
4. At operation 504, the flow 500 may, if the subproblem has any feasible solutions, add the subproblems generated by branching on the integer variables to the list of subproblems.
5. At operation 505, the flow 500 may, if the list of subproblems is empty, return the best solution as the optimal solution to the original problem.
6. At operation 506, the flow 500 may return to operation 502 (e.g., go back to step 2).

Illustratively, the techniques described herein may be performed by hardware, software, and/or firmware, such as in accordance with resource scheduling process 248, which may include computer executable instructions executed by the processor 220 (or independent processor of interfaces 210) to perform functions relating to the techniques described herein.

Specifically, according to various embodiments, a device determines whether applications in a messaging system are data producers or data consumers. The device determines workloads of the applications. The device assigns message brokers of the messaging system to the applications based on the workloads of the applications and whether the applications are data producers or data consumers.

Various examples highlighting aspects of the present disclosure are provided below. It will be appreciated that the following examples are illustrative and are not intended to limit the scope of the disclosure but are provided to illustrate non-limiting examples of the methodologies described herein.

Operationally, FIG. 6 illustrates an example of resource scheduling for applications in a computing system 600. The computing system 600 can be analogous to the computing system 100 illustrated in FIG. 1, the device 200 illustrated in FIG. 2, or the observability platform 300 illustrated in FIG. 3. As shown in FIG. 6, the computing system 600 includes a messaging system 630, which includes various brokers, such as BROKER_1 634a, BROKER_2 634b, and BROKER_3 634c. Further, as shown in FIG. 4, each of the brokers 634a to 634c can have one or more applications, such as the APPLICATION_1 636a, the APPLICATION_2 636b, and the APPLICATION_3 636c associated therewith. The brokers 634a to 634c and/or the applications 636a to 636c can each be associated with various producers and various consumers in accordance with messaging system 630 protocols. It is noted, however, that the producers and consumers are not explicitly illustrated in FIG. 6 so as to not obfuscate the layout of the drawing.

The messaging system 630 and, hence, each of the brokers 634a to 636c, are provisioned with resources (e.g., computing resources) from a processor 638. The processor 638 can be a central processing unit (CPU), controller, microprocessor, block of co-processors, logic circuitry, etc. that is configured to perform various computing functions, such as executing an operating system, applications, and the like.

As described in more detail herein, the messaging system 630 and/or the processor 638 operate to minimize the cost (in terms of computing resources consumed) of all the resources being allocated to various brokers 634a to 634c and, hence, to the producers and consumers associated with the messaging system 630. For example, the messaging system 630 and/or the processor 638 operate to minimize solutions to Equation 1 and/or Equation 2 by executing a simplex algorithm, a branch and bound algorithm, or other similar technique, to allocate resources to the various brokers 634a to 634c in the messaging system 630.

In some embodiments, the messaging system 630 and/or the processor 638 determine workloads associated with the various applications 636a to 636c as part of allocating resources to the brokers 634a to 634c. In addition, or in the alternative, the messaging system 630 and/or the processor 638 can monitor workloads associated with producers and consumers that generate messaging traffic in the messaging system 630 and utilize this information as part of allocating resources to the brokers 634a to 634c.

That is, in some embodiments, the messaging system 630 and/or the processor 638 can determine whether applications in a messaging system are data producers or data consumers and then determine workloads associated with the applications 636a to 636c. The messaging system 630 and/or the processor 638 can then assign brokers 634a to 634c of the messaging system to the applications 636a to 636c based on the workloads of the applications 636a to 636c and whether the applications 636a to 636c are data producers or data consumers. As used herein, a “data producer” (or “producer” for brevity) generally refers to a client application that publishes (e.g., writes) events to the messaging system 630, while a “data consumer” (or “consumer” for brevity) generally refers to a client application that subscribes to (e.g., reads and processes) events from the messaging system 630.

In addition, the messaging system 630 and/or the processor 638 can execute one or more machine learning algorithms in order to perform the operations described herein. For example, the messaging system 630 and/or the processor 638 can monitor workloads associated with the applications 636a to 636c and apply machine learning techniques to the monitored workloads as part of allocating resources to the brokers 634a to 634c. In these embodiments, it will be appreciated that the operations described herein may be performed in the absence of input from a user and therefore the optimization of resource scheduling for applications in a computing system 600 can be performed automatically.

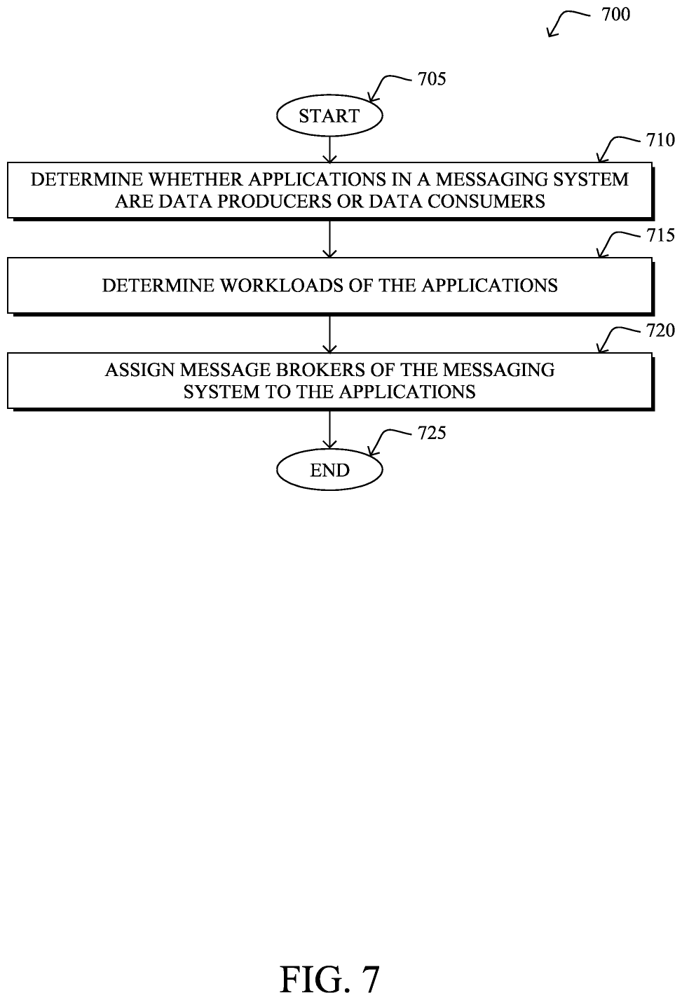

FIG. 7 illustrates an example simplified procedure 700 (e.g., a method) for illustrates an example of resource scheduling for applications. For example, a non-generic, specifically configured device for illustrates an example of resource scheduling for applications (e.g., device 200, processor 438), may perform procedure 700 by executing stored instructions (e.g., resource scheduling process 248). The procedure 700 may start at step 705, and continues to step 710, where, as described in greater detail above, a process may determine whether applications in a messaging system are data producers or data consumers. In some embodiments, the process is performed by a device (e.g., a controller, processor, etc.). In some embodiments, the messaging system can be a distributed event streaming platform, as discussed above.

At step 715, as detailed above, the process determines workloads of the applications. In various embodiments, the applications can be selected from a group consisting of social media applications, financial applications, and online games. It will be appreciated that the workloads associated with these different types of applications may be vastly different therefore making it desirable to determine the workloads associated with the applications in order to provide the application-aware resource scheduling techniques described herein.

At step 720, the process assigns message brokers of the messaging system to the applications based on the workloads of the applications and whether the applications are data producers or data consumers. In various embodiments, the message brokers can be configured to store and process messages produced by the data producers and consumed by the data consumers. Embodiments are not so limited, however, and in some embodiments, assigning the message brokers can be based on correlating CPU and memory availability of individual message brokers to corresponding workloads of the applications.

In some embodiments, assigning the message brokers can be based on an application type and associated characteristics of the applications. In other embodiments, assigning the message brokers can be based on an application-aware resource scheduling algorithm. In yet other embodiments, assigning message brokers can be based on a simplex algorithm or can be based on a branch and bound algorithm. In still yet other embodiments, assigning the message brokers can be based on ensuring application resource requirements do not exceed resource capacity of the message brokers.

Procedure 700 then ends at step 725.

It should be noted that while certain steps within procedure 700 may be optional as described above, the steps shown in FIG. 7 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein therefore provide for a messaging system to assign brokers to different types of applications through the use of resource scheduling. More specifically, by providing for an application-aware scheduling paradigm (e.g., set of executable instructions, algorithm, etc.) to allocate resources (e.g., processing resources, memory resources, etc.) associated with the messaging system and/or network to brokers associated with different producers and consumers, performance of an overall computing system is improved through the optimization of performance of workloads assigned to the various brokers in comparison to previous approaches.

While there have been shown and described illustrative embodiments that provide for resource scheduling for applications, it is to be understood that various other adaptations and modifications may be made within the intent and scope of the embodiments herein. For example, while certain embodiments are described herein with respect to resource scheduling based on application types and/or data types, the techniques herein are not limited as such and may be used in connection with other characteristics, parameters, and the like, of applications and/or microservices. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true intent and scope of the embodiments herein.

What is claimed is:

1. A method, comprising:
determining, by a device, whether applications in a messaging system are data producers or data consumers;
determining, by the device, workloads of the applications; and
assigning, by the device, message brokers of the messaging system to the applications based on the workloads of the applications and whether the applications are data producers or data consumers.

2. The method as in claim 1, wherein the messaging system comprises a distributed event streaming platform.

3. The method as in claim 1, wherein the message brokers are configured to store and process messages produced by the data producers and consumed by the data consumers.

4. The method as in claim 1, wherein assigning message brokers is based on correlating CPU and memory availability of individual message brokers to corresponding workloads of the applications.

5. The method as in claim 1, wherein assigning message brokers is based on an application type and associated characteristics of the applications.

6. The method as in claim 1, wherein assigning message brokers is based on an application-aware resource scheduling algorithm.

7. The method as in claim 1, wherein assigning message brokers is based on a simplex algorithm.

8. The method as in claim 1, wherein assigning message brokers is based on a branch and bound algorithm.

9. The method as in claim 1, wherein assigning message brokers is based on ensuring application resource requirements do not exceed resource capacity of the message brokers.

10. The method as in claim 1, wherein the applications are selected from a group consisting of: social media applications; financial applications; and online games.

11. A tangible, non-transitory, computer-readable medium having computer-executable instructions stored thereon that, when executed by a processor on a computer, cause the computer to perform a method comprising:
determining whether applications in a messaging system are data producers or data consumers;
determining workloads of the applications; and
assigning message brokers of the messaging system to the applications based on the workloads of the applications and whether the applications are data producers or data consumers.

12. The tangible, non-transitory, computer-readable medium as in claim 11, wherein the messaging system comprises a distributed event streaming platform.

13. The tangible, non-transitory, computer-readable medium as in claim 11, wherein the message brokers are configured to store and process messages produced by the data producers and consumed by the data consumers.

14. The tangible, non-transitory, computer-readable medium as in claim 11, wherein assigning message brokers is based on correlating CPU and memory availability of individual message brokers to corresponding workloads of the applications.

15. The tangible, non-transitory, computer-readable medium as in claim 11, wherein assigning message brokers is based on an application type and associated characteristics of the applications.

16. The tangible, non-transitory, computer-readable medium as in claim 11, wherein assigning message brokers is based on an application-aware resource scheduling algorithm.

17. The tangible, non-transitory, computer-readable medium as in claim 11, wherein assigning message brokers is based on a simplex algorithm.

18. The tangible, non-transitory, computer-readable medium as in claim 11, wherein assigning message brokers is based on a branch and bound algorithm.

19. The tangible, non-transitory, computer-readable medium as in claim 11, wherein assigning message brokers is based on ensuring application resource requirements do not exceed resource capacity of the message brokers.

20. An apparatus, comprising:
one or more network interfaces to communicate with a network;
a processor coupled to the one or more network interfaces and configured to execute one or more processes; and
a memory configured to store a process that is executable by the processor, the process, when executed, configured to:
determine whether applications in a messaging system are data producers or data consumers;
determine workloads of the applications; and
assign message brokers of the messaging system to the applications based on the workloads of the applications and whether the applications are data producers or data consumers.
